(19) United States
(12) Patent Application Publication
(10) Pub. No.: US 2015/0187143 A1
(43) Pub. Date: Jul. 2, 2015

(54) RENDERING A VIRTUAL REPRESENTATION OF A HAND

(71) Applicants: Shadi Mere, Ann Arbor, MI (US); Theodore Charles Wingrove, Plymouth, MI (US); Kyle Entsminger, Canton, MI (US)

(72) Inventors: Shadi Mere, Ann Arbor, MI (US); Theodore Charles Wingrove, Plymouth, MI (US); Kyle Entsminger, Canton, MI (US)

(21) Appl. No.: 14/559,396

(22) Filed: Dec. 3, 2014

Related U.S. Application Data
(60) Provisional application No. 61/921,005, filed on Dec. 26, 2013.

(51) Int. Cl. G06T 19/00; G06F 3/0481; G06F 3/01

(52) U.S. Cl. CPC G06T 19/006; G06F 3/017; G06F 3/04817

(57) ABSTRACT

A system and method for rendering a virtual representation of a hand (virtual hand) is provided. The system includes a gesture input receiver to receive information of the hand from a gesture based input system; a virtual hand renderer to render the virtual hand based on the hand; and a display driver to communicate the virtual hand to a receiving device. A system and method for displaying a virtual hand is also provided.

### CLAIM OF PRIORITY

This patent application claims priority to U.S. Provisional Application No. 61/921,005, filed Dec. 26, 2013, entitled “Rendering a Virtual Representation of a Hand,” now pending. This patent application contains the entire Detailed Description of U.S. Patent Application No. 61/921,005.

### BACKGROUND

Various interfaces and machines employ gesture based inputs. The gesture based inputs allow a detection of movement from a cue, such as a body part (commonly the hand), and based on the detected movement or gesture, a command is initiated. The gesture based inputs do not require the user to make contact with a touch pad or device.

The gesture is captured via a video camera or motion detector. Accordingly, the video camera captures the movement, correlates the movement to a stored command center (i.e. a processor and storage device), and translates the movement into an action.

In order to realize the gesture based input, and specifically in the context of a hand creating the gesture, a cloud of data associated with the hand is created. The cloud of data may interact with various virtual objects. Each virtual object may be a non-tangible or non-physical element, and controllable by either movement of the hand or a predetermined gesture, which is detected by the gesture based input system. The virtual object may be rendered on a display.

The gesture based system may determine the hand's location, and based on the determined location, activate various virtual functions. Accordingly, the gesture based system may determine various aspects of the hands, such as the hands dimensions, various orientation and locations of space associated with aspects of the hand (i.e. the fingers and the other protrusions). Once the various aspects are determined, the coordinates in space may correspond to specific functions. Further, displacement in space, from a first time to a second time may also correspond to specific functions.

### DESCRIPTION OF THE DRAWINGS

The detailed description refers to the following drawings, in which like numerals refer to like items, and in which:

FIG. 1 is a block diagram illustrating an example computer.

FIG. 2 is an example of a system for rendering a virtual representation of a hand.

FIG. 3 is an example of a method for rendering a virtual representation of a hand.

FIG. 4 is an example of a system for display a virtual hand according to another exemplary embodiment.

FIG. 5 is an example of a method for display a virtual hand according to another exemplary embodiment.

FIGS. 6(a)-(c) illustrate an example implementation of the systems and methods shown in FIGS. 2-5.

### SUMMARY

Exemplary embodiments disclosed herein provide a system and method for rendering a virtual representation of a hand (virtual hand) is provided. The system includes a gesture input receiver to receive information of the hand from a gesture based input system; a virtual hand renderer to render the virtual hand based on the hand; and a display driver to communicate the virtual hand to a receiving device. A system and method for displaying a virtual hand is also provided.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Gesture based inputs are employed in various situations and contexts. The gesture based input allows for a user or operator to engage with an input or interface without making contact with any surface. The gesture based input is facilitated by a camera or detection technique that allows a gesture to be captured, and a machine or system to be controlled accordingly. The gesture may refer to any portion of a body part that can be controlled and moved. For example, shaking one's hand or pointing a finger may refer to a gesture.

In implementing a gesture based system, the gesturing instrument (i.e. one's hand) may be captured via an image capturing device, a video capturing device, a motion detector or the like. Essentially, the gesture based system retrieves the information associated with the captured hand, and uses information about the hand's location, movement, and actions to instigate various commands and functions. Accordingly, the gesture based system may be used in conjunction with a system to provide the controls and interaction therewith.

Additionally, the gesture based system may be implemented with a display. The display may show various inputs available to the user. Thus, based on the available inputs or menus, the user may interact with the display. However, because the gesture based system detects gestures in space (i.e. a space designated to capture the gesture), and the display is in a static location (for example, in a dashboard portion of a vehicle, and thus, away from the space of the detection), the ease of use may be frustrated. In conventional input systems, a user is accustomed to applying a force directly on, or near an input mechanism. This does not become possible in conventional gesture based systems.

Disclosed herein are methods and systems directed to rendering a virtual representation of a hand to control a gesture based system incorporated with a display. The examples disclosed herein employ a hand, but other elements and body parts may be implemented as well. Accordingly, because a virtual hand is rendered on a display, the user is provided a realistic and contextual user experience.

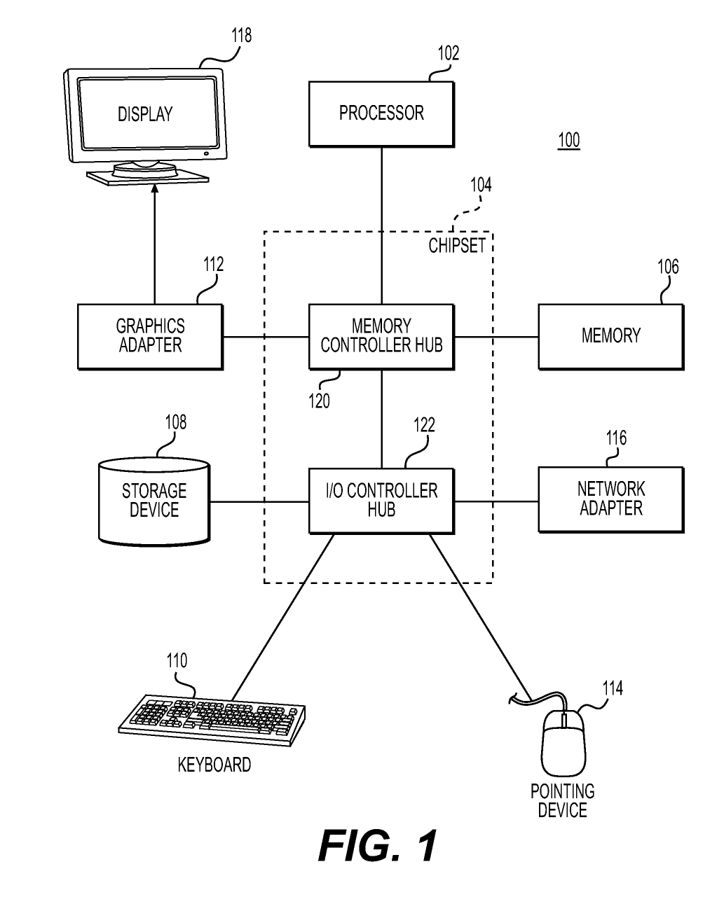

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server.

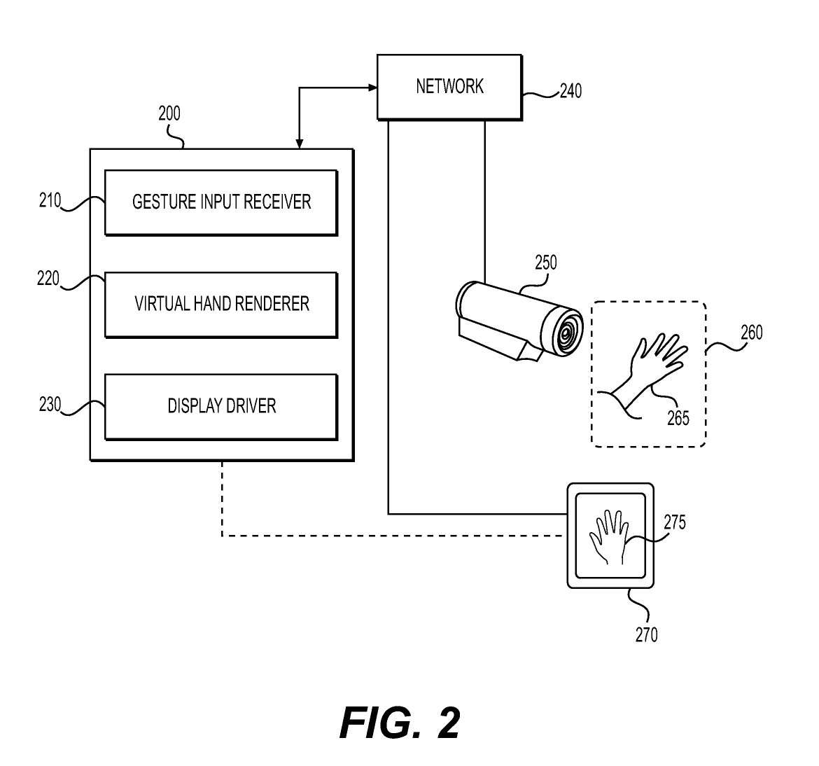

FIG. 2 is an example of a system 200 for rendering a virtual representation of a hand to control a gesture based system incorporated with a display 270. The system 200 may be implemented on a device, such as computer 100.

Referring to FIG. 2, the system 200 is connected to a network 240. The network 240 may allow the system 200 to electrically communicate with various componentry. The network 240 may be any sort of localized or area based network. For example, if the system 200 is implemented in a vehicle, the network 240 and the connections between the various componentry shown in FIG. 2, may be facilitated by an electronic control unit (ECU).

The system 200 may be implemented in any environment or situation where a gesture based input system 250 is employed. For example, the gesture based input system 250 may be situated in a vehicle, and be employed to monitor the gestures made by an operator or passenger of the vehicle. Accordingly, while the operator is driving the vehicle, the operator may make gestures in the gesture detection region 260. Accordingly, the gesture based input system 250 may detect the gesture made in the gesture detection region 260, and transmit a signal or indication to system 200.

As shown in FIG. 2, an appendage (for example a physical hand 265) may be monitored and detected in the gesture detection region 260. Thus, the gesture input receiver 210 may detect the actual presence of an appendage in the area. Additionally, the gesture input receiver 210 may also be configured to determine whether the hand 265 is forming a shape or pattern associated with a predetermined gesture (i.e. pointing, making a fist, etc.).

The gesture input receiver 210 receives data of an element being captured by the gesture based input system 250. As shown, the gesture detection region 260 may detect a hand gesture made in the gesture detection region 260. For example, if the hand gesture of an operator or driver of a vehicle indicates that the operator or driver of the vehicle is pointing in a certain direction, the gesture based input system 250 may record this.

A gesture based system 250 may already record various aspects of the hand, contours, and actions of the hand. Accordingly, coordinate information about the present location of the hand, or the monitored appendage, may be stored in an associated persistent store. Accordingly, the gesture input receiver 210 may receive information already captured via the gesture based input system 250.

The virtual hand renderer 220, based on the data received by the gesture input receiver 210, renders a virtual hand 275. The virtual hand 275 may be created by reconstructing the location of various aspects of the captured hand. In essence, a skeletal structure of a hand may be obtained. The virtual hand 275 may represent the skeletal structure. As shown, the virtual hand 275 is displayed on display 270, as a graphical or pixelated version of the physical hand 265.

The display driver 230 drives a display 270 associated with the gesture based input system 250. The display 270 and the system 250 may be integrally provided. In another example, the system 250 may be provided as a build-on component, and implemented into an already existing display.

The display driver 230 transmits the rendered virtual hand 275 onto the display 270 (either directly or via network 240). For example, as the real hand moves in the space 260, the virtual hand 275 moves accordingly.

In one example, various inputs may be virtualized on the display. For example, an animated version of a rotary knob or switch may be rendered as a graphical depiction of a rotary knob or switch (a GUI element). Accordingly, as the virtual hand 275 is made to move in a simulated way to rotate a rotary knob, the display 270 may represent this action as well.

In another example, the rendered virtual hand 275 may be removed in response to a predetermined time elapsing. Thus, the virtual hand 275 may fade out once a predetermined time or action has been reached. In this way, the virtual hand 275 may serve as a guide, and once the user is cognizant about the location of the hand relative to a virtual object, the virtual hand 275 may be removed from the display 270.

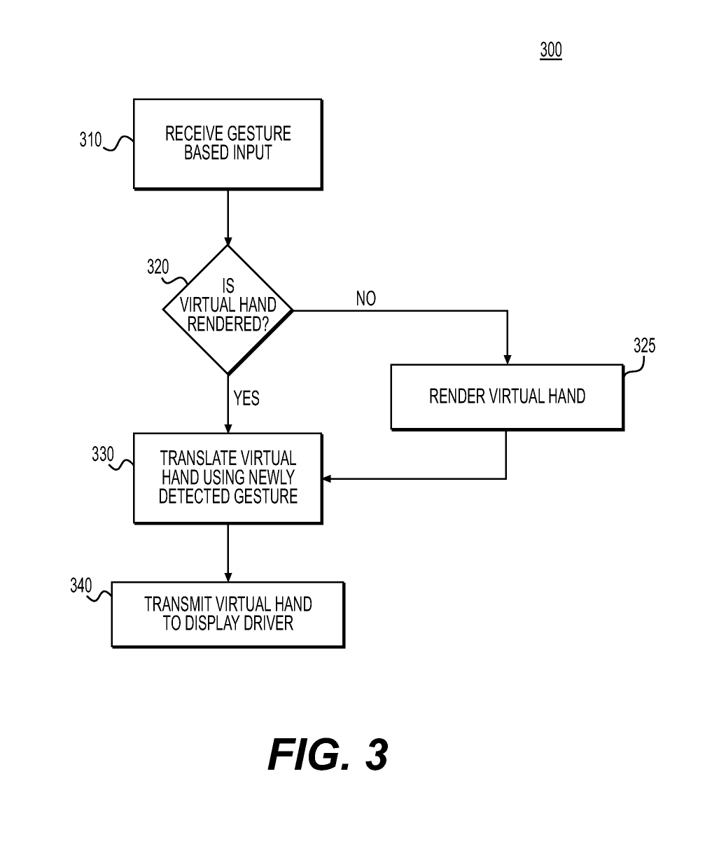

FIG. 3 illustrates a method 300 for rendering a virtual representation of a hand to control a gesture based system. The method 300 may be implemented on a system, such as system 300.

In operation 310, a gesture based input signal is received. As explained above, the gesture may correspond to a recorded non-contact control or input signal. The gesture may be recorded via a motion detection device or camera. The gesture may refer to a detection of an appendage (for example a hand), and a specific shape/form associated with the appendage.

In operation 320, a determination is made as to whether the virtual hand is already rendered. If yes, the method 300 proceeds to operation 330. If not, the method 300 proceeds to operation 325.

In operation 325, a virtual hand is rendered. As explained above, the virtual hand may be built using the data obtain in operation 310. The rendered data may correspond with an animated version of the virtual hand, and accordingly, made to look significantly like the user's hand.

In operation 330, the received gesture is employed to re-render the virtual hand. Thus, if the gesture detected in in operation 310 is different than the already existing virtual hand on a display, the virtual hand is re-rendered to replicate the newly capture gesture.

In operation 340, the rendered virtual hand is communicated to a display. The rendered virtual hand may interact with rendered virtual objects (such as virtual knobs and virtual switches). The rendered virtual knobs and switches may interact with the virtual hand in a way similar to a real hand interacting with a virtual knob. Thus, if a user makes a pointing and pressing motion in midair, the display screen may show the virtual hand pointing and pressing a graphical user interface.

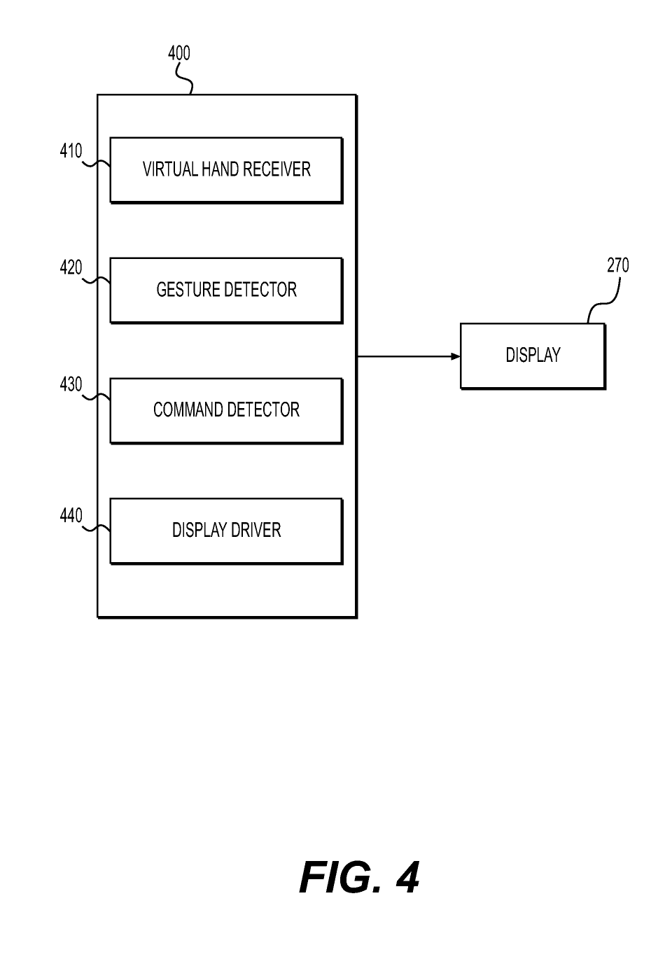

FIG. 4 is an example of a system 400 for displaying a virtual hand according to another exemplary embodiment. The system 400 may be implemented on a device, such as computer 100 described above. The system 400 includes a virtual hand receiver 410, a gesture detector 420, a command detector 430, and a display driver 440. The display driver 440 may communicate with a display 270 (either directly or via a network 250).

Further, the aspects described with system 400 may be wholly or selectively combined with system 200.

The virtual hand receiver 410 receives data associated with a virtual hand, for example, the virtual hand 275 shown above. The virtual hand 275 may be associated with a specific gesture (for example, a finger pointing, a select number of fingers closed, a fist, etc.).

The gesture detector 420 detects a gesture associated with the virtual hand 275, and cross-references a lookup table as to whether the detected gesture corresponds to a command initiation technique. For example, a finger pointing gesture may correlate to an assertion of a button. A rotation motion may correspond to turning a knob.

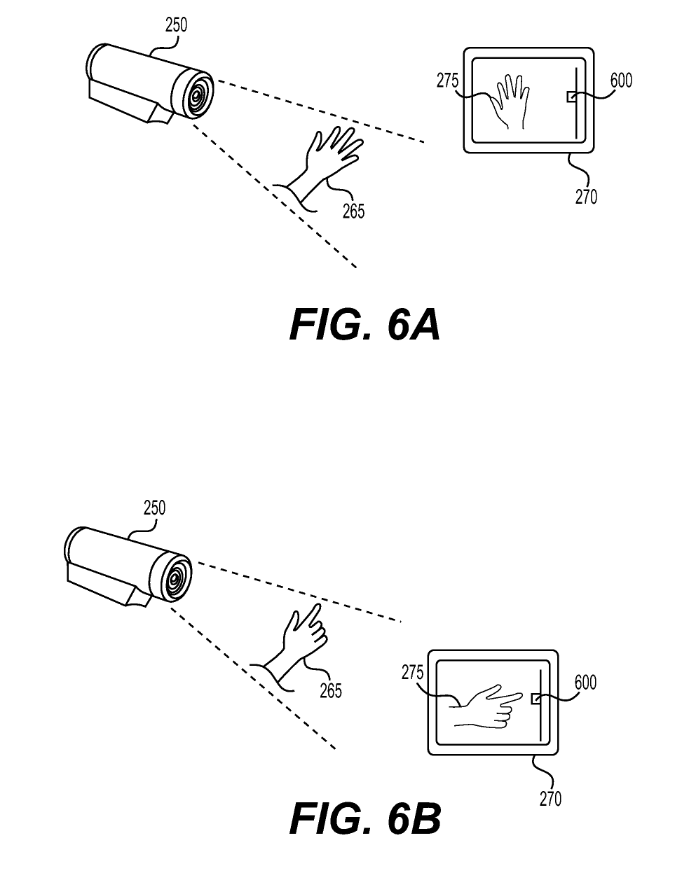

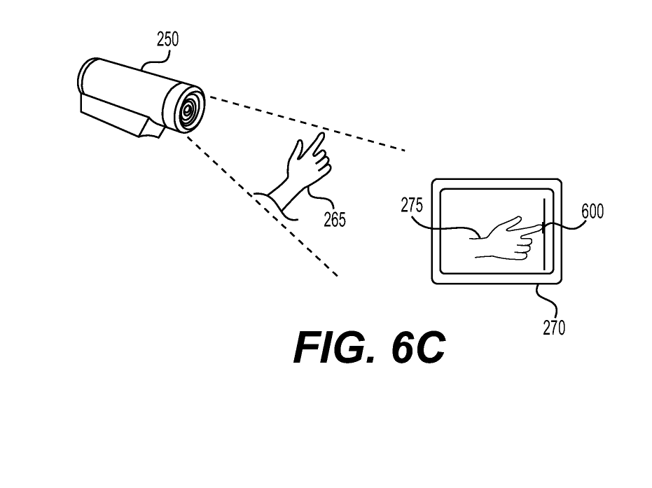

The command detector 430 detects whether the virtual hand 275 corresponds to a location on the display 275 that corresponds with the initiation of the command. For example, as shown in FIGS. 6(a)-(c), the virtual hand 275 is moved to a position to assert a GUI element 600. If the virtual hand 275 corresponds to an initiation of the command, and is in a predetermined area for the initiation of the command—the actual command associated with the action is transmitted to the display 270.

The display driver 440 may communicate to the display 270 that a command is initiated. Accordingly, the display 270 may be instructed to replicate an animation associated with the virtual hand 275 performing the action detected. In another example, the system 400 may communicate to an electronic system associated with the display 270 a signal initiating an action.

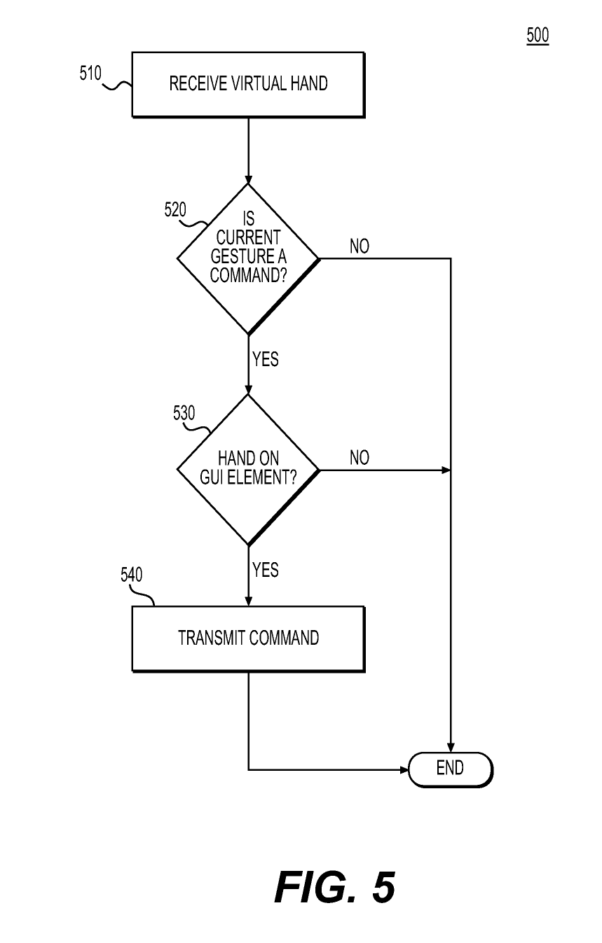

FIG. 5 illustrates an example of a method 500 for displaying a virtual hand according to another exemplary embodiment. The method 500 may be performed on a device, such as computer 100 described above.

In operation 510, a virtual hand is received. This prompts the determination in operation 520, which determines whether a current gesture associated with an initiation of a command. If no, the method 500 proceeds to end.

If yes, the method 500 proceeds to operation 530. In operation 530, a determination is made as to whether the virtual hand is on a GUI element, or with a predetermined distance. If yes, the command associated with the gesture and the GUI element, is transmitted to either a display or electronic system in communication with the interface associated with method 500. If no, the method 500 proceeds to end.

In another implementation of method 500, another operation (not shown) may be performed to verify if the correct gesture is associated with the GUI element being interacted with. For example, if the GUI element looks like a rotary knob, a twisting gesture may be required to interact with the GUI element.

FIGS. 6(a)-(c) illustrate an example of an implementation of a system 200 and system 400 described above.

As shown in FIG. 6(a), a gesture based input system 250 detects an appendage (a hand 265) interacting with the electronic system or display 270. Accordingly, the display 270 illustrates a virtual hand 275 on the display. The virtual hand 275 may replicate the gesture or stance that hand 265 resides in. Also shown in the display 270 is a GUI element 600. The GUI element 600 may be associated with an operation of a function of an electronic system.

Referring to FIG. 6(b), the hand 265 changes a gesture (and now resides in a position in which the hand is pointing). The virtual hand 275 is also re-rendered to reflect this change.

Referring to FIG. 6(c), the hand 265 may be moved (for example in a space 260). The motion of the hand 265 may be moved in a way to cause the virtual hand 275 to move in a similar fashion. Thus, the virtual hand 275 may be moved in a way to assert the GUI element 600. The display 270 may accordingly re-render the GUI element 600 to show that the element 600 has been asserted. Once asserted, the function associated with the GUI element 600 may be initiated.

For example, if the system 200 and 400 is implemented in a vehicle, the assertion of element 600 may be associated with a function tied to the operation of the vehicle (turning on a HVAC system, opening a window, opening a sunroof, or the like).

Thus, employing the aspects disclosed herein, a gesture based input system may provide an enhanced user experience by providing a virtual hand that interacts with graphical and virtual objects.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM), The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 3 and 5. The disclosed devices, components, and systems contemplate using or implementing any suitable technique for performing the steps illustrated in these figures. Thus, FIGS. 3 and 5 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for rendering a virtual representation of a hand (virtual hand), comprising:
a gesture input receiver to receive information of the hand from a gesture based input system;
a virtual hand renderer to render the virtual hand based on the hand; and
a display driver to communicate the virtual hand to a receiving device.

2. The system according to claim 1, wherein the virtual hand renderer renders the virtual hand based on a detected location of hand relative to a detection space.

3. The system according to claim 1, wherein the virtual hand renderer renders the hand based on the hand's gesture.

4. The system according to claim 2, wherein the virtual hand renderer renders the hand based on the hand's gesture.

5. The system according to claim 4, wherein the virtual hand renderer initiates the virtual hand in response to a display not rendering the virtual hand, and changes a gesture of the virtual hand in response to the display rendering the virtual hand.

6. The system according to claim 1, wherein the virtual hand is configured to interact with a graphical user interface (GUI) element associated with the receiving device.

7. The system according to claim 6, wherein the GUI element is an icon associated with a push-able element.

8. The system according to claim 6, wherein the GUI element is an icon associated with a rotate-able element.

9. A method for rendering a virtual representation of a hand (virtual hand), comprising:
receiving a gesture based input of a hand;
rendering a virtual hand based on the hand; and
transmitting the virtual hand to a receiving device.

10. The method according to claim 9, wherein the receiving further comprises receiving a gestured associated with the hand, and the rendering further comprises rendering the virtual hand based on the hand and the gesture.

11. The method according to claim 10, wherein the rendering further comprises rendering the virtual hand relative to a location of the hand in a detection space.

12. The method according to claim 9, wherein the in response to no virtual hand being displayed, the rendering render the virtual hand, and in response to the virtual hand already being displayed, the rendering updates the virtual hand based on a detected gesture associated with the hand.

13. The method according to claim 9, wherein the virtual hand is configured to interact with a graphical user interface (GUI) element associated with the receiving device.

14. The method according to claim 13, wherein the GUI element is an icon associated with a push-able element.

15. The method according to claim 13, wherein the GUI element is an icon associated with a rotate-able element.

16. The method according to claim 9, wherein the virtual hand is removed from a display after a predetermined time elapses.

17. A system for displaying a virtual hand, comprising:
a virtual hand receiver to receive data associated with a virtual hand;
a gesture detector to detect a gesture based on the virtual hand received;
a command detector to determine whether the gesture and the virtual hand's location correspond to a command; and
a display driver to communicate an indication of the command to a receiving device.

18. The system according to claim 17, wherein the command corresponds to a function associated with an electronic system.

19. The system according to claim 18, wherein the electronic system is implemented in a vehicle.

20. The system according to claim 17, wherein the command detector is further configured to determine whether the gesture is a correct gesture for the associated location.
